(19) United States
(12) Patent Application Publication
(10) Pub. No.: US 2026/0252159 A1
(43) Pub. Date: Aug. 27, 2026

(54) BATTERY REMOVAL AND INSERTION SCHEME

(71) Applicant: QUALCOMM Incorporated, San Diego, CA (US)

(72) Inventors: Utkarsh VINAYAK, Patna (IN); Nirav Narendra DESAI, Hyderabad (IN); Shriharsha CHEBBI, Hyderabad (IN); Valmick GUHA, Hyderabad (IN)

(21) Appl. No.: 19/063,022

(22) Filed: Feb. 25, 2025

(51) Int. Cl. G06F 1/3234; G06F 1/324

(52) U.S. Cl. CPC G06F 1/3243; G06F 1/324; G06F 1/3275

(57) ABSTRACT

A device comprising a system-on-a-chip (SoC) is provided. The SoC is configured to receive information from a power management integrated circuit (PMIC) that a battery in the device was removed or will be removed, and store context data associated with the device based on the received information. The SoC further includes a battery event manager. The battery event manager is configured to store the context data associated with the device based on a timer. If the timer is greater than a first timer threshold, the battery event manager transitions the boot core to a deeper low-power mode (LPM) than a current LPM and the SoC to a sleep state. If the timer is greater than a second timer threshold, the battery event manager wakes up dynamic random access memory (DRAM) and copies the context data from the DRAM into non-volatile memory.

### TECHNICAL FIELD

The present disclosure relates generally to electronic devices and, more particularly, to power management in the devices.

### INTRODUCTION

Various electronic devices, such as medical devices and Internet of Things (IoT) devices, rely on battery power. When the battery level becomes low, the battery may need to be replaced with a charged battery, as many devices do not support recharging the drained battery. To maintain continuous device operation and retain context data of the device during the battery replacement process, a backup power source (e.g., a backup capacitor) may be provided. However, the backup power has a limited capacity and may sustain the device only for a short period of time. Hence, the battery replacement needs to be completed within this time frame to prevent abrupt shutdown, which may result in the loss of the device context data. Example aspects presented herein provide methods and apparatus for saving data to non-volatile memory (NVM) based on time and power levels after battery removal.

### BRIEF SUMMARY

In an aspect of the disclosure, a device includes a system-on-a-chip (SoC). The SoC is configured to receive information from a power management integrated circuit (PMIC) that a battery in the device was removed or will be removed; and store, based on the received information, context data associated with the device. In some aspects, the SoC may include a battery event manager, which may be configured to receive the information from the PMIC and to store the context data based on the received information. In some examples, the battery event manager may be configured to transition one or more subsystems (SS) of the device to a power collapse (PC) mode and to transition the boot core (e.g., the primary processing core within the SoC that is responsible for executing the initial boot sequence) of the device to a low power mode (LPM) upon receiving the information from the PMIC. In some examples, the battery event manager may be configured to store the context data associated with the device based on a timer. For example, the battery event manager may be configured to transition the boot core to a deeper LPM and transition the SoC to a sleep state if the timer is greater than a first timer threshold. If the timer is greater than a second, higher timer threshold, the battery event manager may be configured to wake up the dynamic random access memory (DRAM) and transfer the context data from the DRAM into non-volatile memory (NVM).

### BRIEF DESCRIPTION OF THE DRAWINGS

FIG. 1 is a diagram illustrating an entry flow of a battery replacement scheme in accordance with various aspects of the present disclosure.

FIG. 2 is a diagram illustrating various subsystems in a device in accordance with various aspects of the present disclosure.

FIG. 3 is a diagram illustrating an entry flow of a modem in accordance with various aspects of the present disclosure.in accordance with various aspects of the present disclosure.

FIG. 4 is a diagram illustrating an exit flow of a battery replacement scheme in accordance with various aspects of the present disclosure.

FIG. 5 is a flowchart illustrating a method of a battery replacement process of a device in accordance with various aspects of the present disclosure.

FIG. 6 is a flowchart illustrating a method of a battery replacement process of a device in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. Apparatuses and methods will be described in the following detailed description and may be illustrated in the accompanying drawings by various blocks, modules, components, circuits, steps, processes, algorithms, elements, etc.

Various electronic devices, such as medical devices and IoT devices, rely on battery power. When the battery level becomes low, the battery may need to be replaced with a charged battery, as many devices do not support recharging the drained battery. To maintain continuous device operation and retain context data of the device (e.g., system configurations, user settings, historical data) during the battery replacement process, a backup power source (e.g., a backup capacitor) may be provided. However, the backup power has a limited capacity and may sustain the device for only a short period of time (e.g., a few minutes). Hence, the battery replacement needs to be completed within this time frame to prevent abrupt shutdown, which may result in the loss of the device context data.

Therefore, it is necessary to have a framework that can be invoked to initiate necessary context data saving and restoration operations without user intervention when the battery replacement process begins. Additionally, once the device is powered on after battery replacement, this framework may enable the device to resume operation by restoring the saved context. Example aspects presented herein provide methods and apparatus for saving data to NVM based on time and power levels after battery removal.

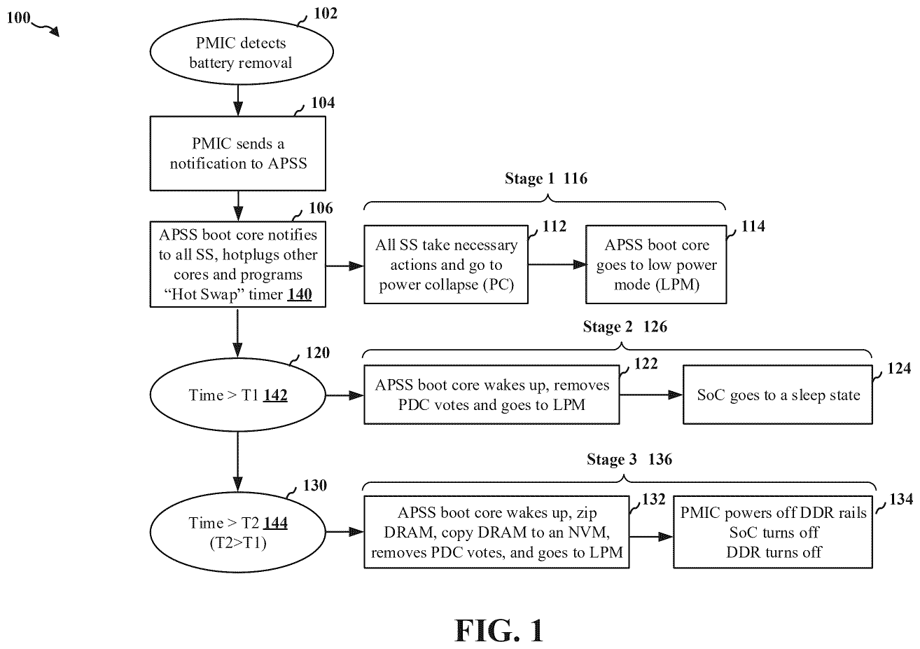

FIG. 1 is a diagram 100 illustrating an entry flow of a battery replacement scheme in accordance with various aspects of the present disclosure. As an example, the battery replacement scheme may be implemented in a system-on-a-chip (SoC) of a battery-powered device to ensure continuous operation and data retention during battery replacement. Such devices may include, for example, medical devices, IoT devices, wearable devices, and remote sensor devices.

As shown in FIG. 1, during the battery replacement process, a power management integrated circuit (PMIC) may, at 102, detect the battery removal or anticipate that a battery will be removed. For example, the PMIC may detect the battery removal or an impending removal based on sensors associated with the device's battery. For example, this detection may be achieved through a sensor that identifies the opening of the battery compartment or a sensor that detects the cutoff of power from the battery (e.g., due to its removal).

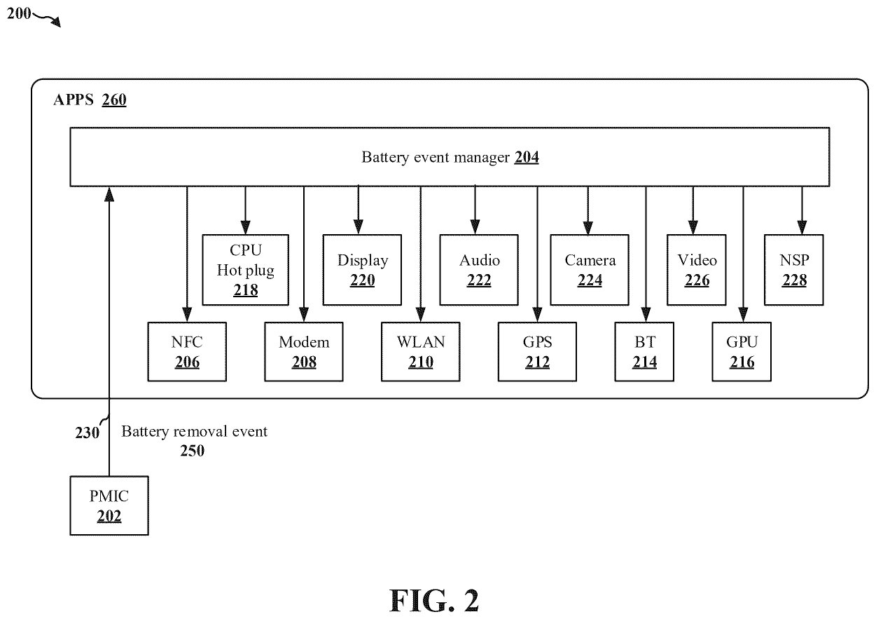

Upon the detection of the battery removal or an impending removal, the PMIC may, at 104, send a “battery removal” notification to a battery event manager module in the application (AP) subsystem (SS) (APSS). In some examples, the PMIC and the APSS may be located on separate SoCs. In some examples, the APSS may have multiple cores. One of the cores may be the boot core, which may be the primary processing core within the SoC that is responsible for executing the initial boot sequence. In some examples, the boot core may receive the “battery removal” notification from the PMIC. FIG. 2 is a diagram 200 illustrating various subsystems in a device in accordance with various aspects of the present disclosure. As shown in FIG. 2, the battery event manager module 204 may be a module that handles incoming power interrupts (e.g., due to battery removal) and sends the information to the relevant SS modules running on the APSS 260.

In response to the “battery removal” notification, the APSS may, at 106, program a “Hot Swap” timer 140 and send notifications to all SS. In some examples, the “Hot Swap” timer 140 may start when the battery replacement process begins, such as when the main battery of the device is removed and the device is powered by a backup power (e.g., a backup capacitor). In some examples, the APSS may initiate the hot-plug process. As used herein, a “hot-plug” process of a device is a process to remove or shutdown a component (e.g., a subsystem) while the device remains powered on and operational. In some examples, as shown in FIG. 1, the hot-plug process may include stage 1 116 of the battery removal process. In stage 1 116, all cores, except the boot core, may be hot-plugged and take necessary actions (e.g., at 112) and enter power collapse (PC) mode. The PC mode may refer to a power-saving mode in which the SoC significantly reduces power consumption by shutting down most of its subsystems. Power collapse simply means “Turn OFF.” Each individual SS can go to PC independently. Each core in CPU can go to PC independently. As needed, the software (SW) can initiate PC of any independent core and SS. Meanwhile, the boot core may transition into a low power mode (LPM) (e.g., at 114). As used herein, the boot core may refer to the primary processing core within the SoC that is responsible for executing the initial boot sequence.

Referring to FIG. 2, upon detecting a battery removal event 250 (e.g., a battery has been removed or is about to be removed), the PMIC 202 may, at 230, send a “battery removal” notification to a battery event manager module 204 in the APSS 260.

As shown in FIG. 2, the battery event manager module 204 may be associated with various subsystem modules. For example, these subsystems may include one or more of the following: near field communication (NFC) 206, modem 208, wireless local area network (WLAN) 210, global positioning system (GPS) 212, Bluetooth (BT) 214, graphics processing unit (GPU) 216, central processing unit (CPU) hot plug 218, display 220, audio 222, camera 224, video 226, or neural signal processor (NSP) 228.

Upon receiving the information about the power interrupts from the battery event manager module 204, each subsystem module may communicate this information to its corresponding SS and facilitate the necessary actions accordingly. Table 2 shows examples of actions taken by various subsystems in response to information about power interruptions.

TABLE 2
.Example actions by various subsystems in response
to information about power interruptions

| Subsystems/Attaches | Action and APSS notifications |
|---|---|
| Modem | E911 |
| WLAN | OFF (only if already ON) |
| BT | OFF (only if already ON) |
| Audio | Audio activity paused, no audio |
| | capture, no audio playback, may enter |
| | full power collapse (PC) mode |
| NSP | Deepest low power mode (LPM) |
| Camera | OFF |
| Video | OFF |
| GPU | OFF |
| Display | ON |
| GPS | OFF (only if already ON) |
| NFC | OFF (only if already ON) |

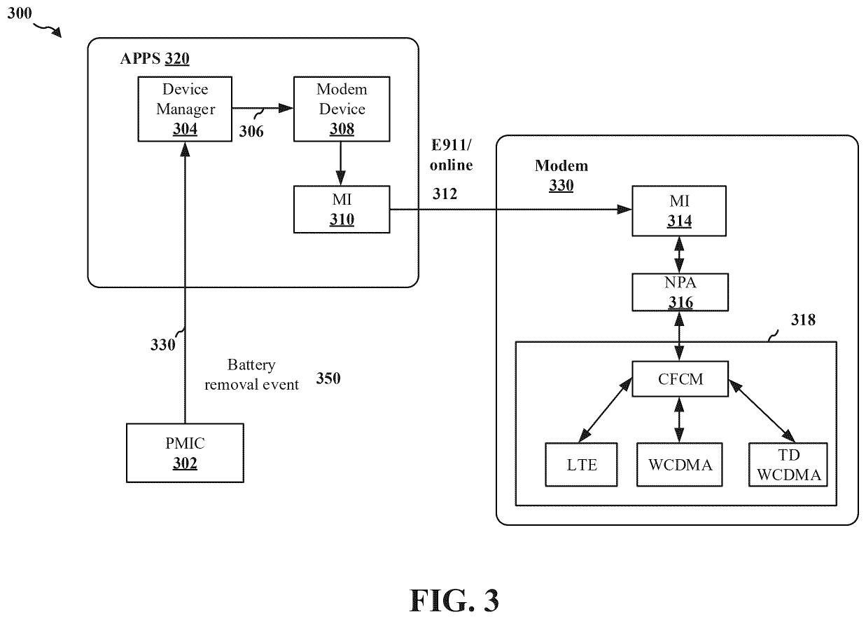

As shown in Table 2, upon receiving the information about the power interruption from the battery event manager module 204, the modem 208 may enter an emergency mode. FIG. 3 is a diagram 300 illustrating an entry flow of a modem in accordance with various aspects of the present disclosure. As shown in FIG. 3, when PMIC 302 detects a battery removal event 350 (e.g., a battery has been removed or is about to be removed), the PMIC 302 may, at 330, send a “battery removal” notification to a battery event manager module (e.g., device manage 304). The battery event manager module (e.g., device manage 304) may indicate, via 306, the modem module 308 running on the APSS 320 to enter an emergency mode. In some examples, the state transition may be communicated by the modem module 308 running on the APSS 320 through the messaging interface 310. As part of this process, the modem module 308 running on the APSS 320 may send an E911 signal 312, indicating that the modem module 308 has been placed in airplane mode. This signal may be received by the messaging interface 314 in the modem subsystem 330 and transmitted to a node power architecture (NPA) 316, which is responsible for communicating with actual hardware modules 318. In some examples, to manage this event efficiently, a new node may be programmed to handle the battery removal event. This node may be responsible for coordinating actions across various subsystems and ensuring appropriate responses to the battery removal notification.

As shown in Table 2, upon receiving the information about the power interruption from the battery event manager module 204, various subsystems may take corresponding actions in response to the power interruption. For example, the WLAN 210 may enter into an OFF mode, BT 214 may enter into an OFF mode, and audio 222 may enter into an audio pause mode, where the audio activity may be paused, and audio capture and playback is halted. In some examples, audio 222 may enter a full power collapse (PC) mode. Additionally, the NSP 228 may enter into the LPM, the camera 224, the video 226, the GPU 216, the GPS 212, and the NFC 206 may enter into the OFF mode. In some examples, the display 220 may in an ON mode.

As shown in FIG. 1, two timer thresholds (e.g., T1 142 and T2 144) may be configured. The “Hot Swap” timer 140, programmed by the APSS at 106, may be compared with the two timer thresholds (e.g., T1 142 and T2 144). Depending on the comparison results, the APSS may perform corresponding actions. These two timer thresholds (e.g., T1 142 and T2 144) may serve as threshold times for triggering deeper power-saving stages, such as stage 2 126 and stage 3 136. In some examples, these two timer thresholds (e.g., T1 142 and T2 144) be user-configurable. In some examples, these two timer thresholds (e.g., T1 142 and T2 144) be based on the backup capacitor having a particular percentage of remaining energy stored for powering the SoC.

In some examples, the SoC may include a backup power (e.g., a capacitor) to store energy and sustain the operation of the SoC during the battery replacement process. The first timer threshold T1 142 may be set based on the capacitor having a specific percentage of the remaining energy stored in the capacitor. For example, the first timer threshold T1 142 may be set at approximately 50% (e.g., 50%±1%) of the energy stored for powering the SoC. If the elapsed time exceeds the first timer threshold T1 142 (e.g., at 120), the APSS may enter stage 2 126 of the battery replacement process. In stage 2 126, the APSS boot core wakes up and removes power domain controller (PDC) votes, allowing the APSS to enter a deeper LPM to optimize power consumption while awaiting battery replacement (e.g., at 122). In some examples, the SoC may transition into a sleep state (e.g., at 124) upon determining that the “Hot Swap” timer 140 is greater than the first timer threshold T1 142.

In some examples, while the SoC remains in the sleep state (e.g., at 124), the SoC may continue to consume a small amount of power. If the battery is not replaced for an extended period, the backup capacitor may eventually be depleted. To prevent data loss, all necessary context data may be saved before the memory (e.g., dynamic random-access memory (DRAM)) loses power. Hence, when the “Hot Swap” timer 140 exceeds the second timer threshold T2 144 (e.g., at 130), the APSS may enter stage 3 136 of the battery replacement process. In some examples, the second timer threshold T2 144 may be based on a time period for waking up the memory (e.g., dynamic random access memory (DRAM)) and copying the context data from the DRAM into the non-volatile memory. In some examples, the value of the second timer threshold T2 144 may be set to ensure that sufficient time is available for executing the necessary operations before the SoC is completely powered off. For example, the second timer threshold T2 144 may be based on the capacitor having a particular percentage (e.g., 5%) of remaining energy stored for powering the SoC upon completion of the copying of the context data from the RAM into the non-volatile memory. In some examples, the second timer threshold T2 144 may be greater than the first timer threshold T1 142.

In stage 3 136, the APSS boot core may wake up, compress the DRAM contents, and copy them to a non-volatile memory (NVM) at 132. In some examples, the NVM may be such as a Flash memory. In some examples, the APSS may remove PDC votes and go to LPM. In some examples, the PMIC may power off DDR memory rails. In some examples, the SoC and the DDR may turn off (e.g., at 134).

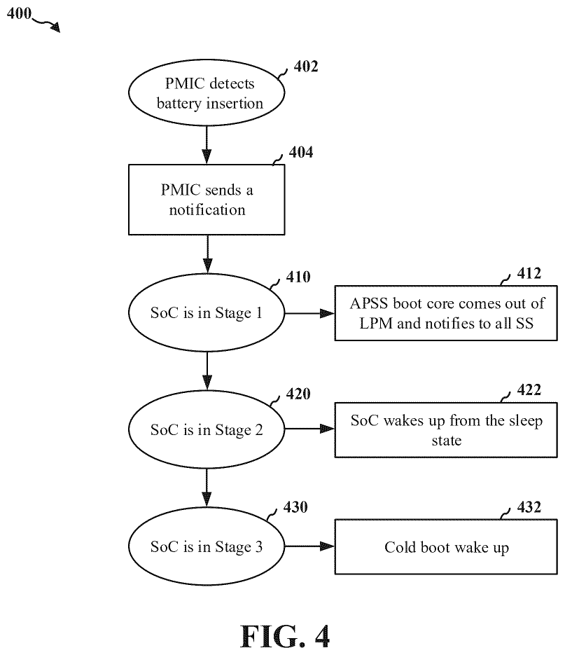

In some aspects, when the battery replacement is completed (e.g., when the new battery is inserted), the PMIC detects the battery insertion event and notifies the SoC, promoting the SoC to exit the battery replacement process. FIG. 4 is a diagram 400 illustrating an exit flow of a battery replacement scheme in accordance with various aspects of the present disclosure.

As shown in FIG. 4, when the battery replacement is completed, the PMIC (e.g., PMIC 202) may, at 402, detect the battery insertion event and, at 404, send a notification to the SoC. Based on the stage it was in during battery removal (e.g., state 1 116, state 2 126, or state 3 136), the SoC may exit the battery replacement process accordingly. As shown in FIG. 4, at 410, if the SoC is in stage 1 (e.g., stage 1 116) at the time it receives the notification (e.g., at 404) from the PMIC, the SoC may exit stage 1. For example, at 412, the APSS boot core may come out of LPM and send notifications to all SS (e.g., modem 208, WLAN 210, GPS 212, BT 214, GPU 216). In some examples, the APSS may bring the other cores out of reset. Table 3 shows the example actions taken by the SS upon receiving the notification from the APSS boot core to exit from stage 1.

TABLE 3
Example actions taken by the SS to exist from stage 1

| Subsystems/Attaches | Actions on Exit from stage 1 |
|---|---|
| Modem | Modem HM online, certain DC |
| WLAN | ON (if turned off during entry) |
| BT | ON (if turned off during entry) |
| Audio | Certain Duty cycle (DC) |
| NSP | Certain DC |
| Camera | Manual turn on by user |
| Video | Manual turn on by user |
| GPU | Workload based wakeup |
| Display | ON |
| GPS | ON (if turned off during entry) |
| NFC | ON (if turned off during entry) |

In some examples, at 420, the SoC may be in stage 2 (e.g., stage 2 126) at the time it receives the notification from the PMIC (e.g., at 404). To exit from stage 2 126, the PDC may initiate the wake-up process of the SoC at 422, allowing the SoC to transition out of the sleep state (e.g., the sleep state at 124).

In some examples, at 430, the SoC may be in stage 3 (e.g., stage 3 136) at the time it receives the notification from the PMIC (e.g., at 404). To exit from stage 3 136, upon receiving the battery insertion notification, the SoC may undergo a cold boot wake-up sequence (e.g., at 432), restoring power and resuming normal operation.

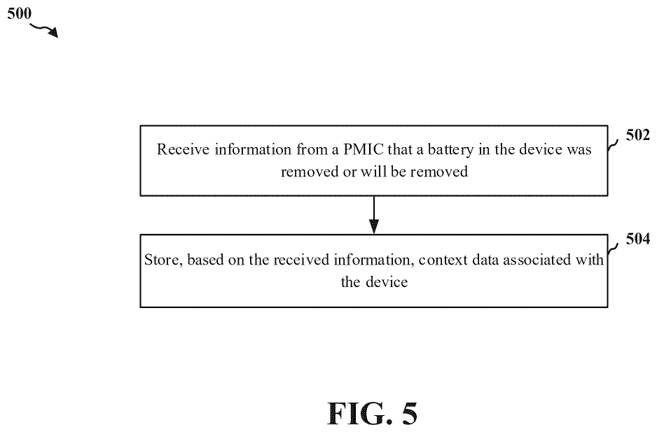

FIG. 5 is a flowchart 500 illustrating a method of a battery replacement process of a device in accordance with various aspects of the present disclosure. The method may be performed by the device. In some examples, the device may include a SoC. By detecting battery removal through the PMIC of a device and saving device context before the backup capacitor of the device is drained, the methods prevent data loss and ensure a smooth resumption of operations after battery replacement, thereby reducing downtime and improving user experience. Additionally, by utilizing a configurable threshold-based context-saving mechanism, the methods enable adaptive power-saving strategies based on specific application needs. In some examples, by providing a scalable and customizable battery replacement scheme, the methods allow customers and manufacturers to fine-tune power management strategies based on different device capabilities and application conditions, thereby improving overall device reliability and efficiency.

As shown in FIG. 5, at 502, the device may receive information from a power management integrated circuit (PMIC) that a battery in the device was removed or will be removed. FIG. 1, FIG. 2, FIG. 3, and FIG. 4 illustrate various aspects of the steps in connection with flowchart 500. For example, referring to FIG. 1, the PMIC may detect the battery removal at 102 and, at 104, send information (e.g., a notification) that a battery in the device was removed or will be removed. Referring to FIG. 2, the PMIC 202 may detect the battery removal event 250 and, at 230, send information (e.g., a notification) that a battery in the device was removed or will be removed to the battery event manager module 204.

At 504, the device may store, based on the received information, context data associated with the device. For example, referring to FIG. 1, based on the received information (e.g., the notification at 104), the device may store context data associated with the device (e.g., copy DRAM to an NVM at 132).

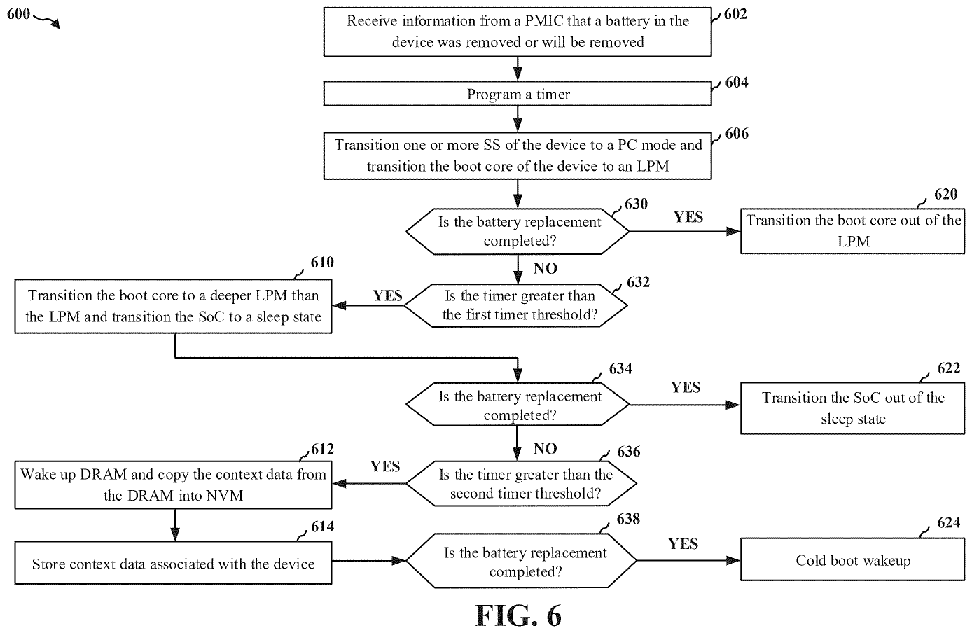

FIG. 6 is a flowchart 600 illustrating a method of a battery replacement process of a device in accordance with various aspects of the present disclosure. The method may be performed by the device. In some examples, the device may include a SoC. By detecting battery removal through the PMIC of a device and saving device context before the backup capacitor of the device is drained, the methods prevent data loss and ensure a smooth resumption of operations after battery replacement, thereby reducing downtime and improving user experience. Additionally, by utilizing a configurable threshold-based context-saving mechanism, the methods enable adaptive power-saving strategies based on specific application needs. In some examples, by providing a scalable and customizable battery replacement scheme, the methods allow customers and manufacturers to fine-tune power management strategies based on different device capabilities and application conditions, thereby improving overall device reliability and efficiency.

As shown in FIG. 6, at 602, the device may receive information from a PMIC that a battery in the device was removed or will be removed. FIG. 1, FIG. 2, FIG. 3, and FIG. 4 illustrate various aspects of the steps in connection with flowchart 600. For example, referring to FIG. 1, the PMIC may detect the battery removal at 102 and, at 104, send information (e.g., a notification) that a battery in the device was removed or will be removed. Referring to FIG. 2, the PMIC 202 may detect the battery removal event 250 and, at 230, send information (e.g., a notification) that a battery in the device was removed or will be removed to the battery event manager module 204.

At 614, the device may store, based on the received information, context data associated with the device. For example, referring to FIG. 1, based on the received information (e.g., the notification at 104), the device may store context data associated with the device (e.g., copy DRAM to an NVM at 132).

In some aspects, the SoC may include a battery event manager, and the battery event manager is configured to receive the information from the PMIC and store the context data based on the received information. For example, referring to FIG. 2, the SoC may include a battery event manager module 204, and the battery event manager module 204 may be configured to receive the information (e.g., at 230) from the PMIC 202 and store the context data based on the received information.

In some aspects, at 604, the SoC may program a timer. For example, referring to FIG. 1, the timer may be the “Hot Swap” timer 140. In some examples, the timer (e.g., the “Hot Swap” timer 140) may start when the battery replacement process begins, such as when the main battery of the device is removed and the device is powered by a backup power (e.g., a backup capacitor). In some examples, the timer may continue to run until the battery replacement process is completed. Based on the duration of the battery replacement process, as indicated by the value of the timer, the battery event manager module 204 may perform different actions during the battery replacement process.

In some aspects, at 606, the battery event manager may be configured to transition one or more subsystems (SS) of the device to a power collapse (PC) mode and to transition a boot core of the device to a low power mode (LPM) upon receiving the information from the PMIC. For example, referring to FIG. 2, the battery event manager module 204 may be configured to transition one or more SS of the device to a PC mode and to transition a boot core of the device into an LPM upon receiving the information from the PMIC 202. For example, the one or more SS may include NFC 206, modem 208, WLAN 210, GPS 212, BT 214, GPU 216, CPU hot plug 218, display 220, audio 222, camera 224, video 226, or NSP 228.

In some aspects, to transition the one or more SS of the device to the PC mode (e.g., at 604), the device may transition one or more of: a modem into an emergency mode, a WLAN into an OFF mode, Bluetooth into an OFF mode, audio into an audio pause mode, a neural signal processing (NSP) SS into an LPM, a camera into an OFF mode, a video into an OFF mode, a GPU into an OFF mode, a display into an ON mode, a GPS into an OFF mode, or NFC into an OFF mode. For example, referring to FIG. 2 and Table 2, when transitioning the one or more SS of the device to the PC mode, the device may transition one or more of: modem 208 into an emergency mode (e.g., E911 mode), WLAN 210 into an OFF mode, BT 214 into an OFF mode, audio 222 into an audio pause mode, NSP 228 into an LPM, camera 224 into an OFF mode, video 226 into an OFF mode, GPU 216 into an OFF mode, display 220 into an ON mode, GPS 212 into an OFF mode, or NFC 206 into an OFF mode.

In some aspects, the device may determine, at 630, whether the battery replacement process has completed.

In some aspects, at 620, after detecting a replacement of the battery (e.g., determining that the battery replacement process has completed at 630), the battery event manager may be configured to transition the boot core out of the LPM. For example, referring to FIG. 4, after detecting a replacement of the battery (e.g., after receiving the notification from the PMIC at 404) and the SoC is in stage 1 (e.g., at 410), the battery event manager may be configured to transition, at 412, the boot core out of the LPM.

In some aspects, the battery event manager may be configured to store the context data associated with the device (e.g., at 614) based on a timer. For example, the battery event manager may compare the timer with the first timer threshold (e.g., at 632) and the second timer threshold (e.g., at 636), and perform corresponding steps based on the comparison results. For example, referring to FIG. 1, the battery event manager may be configured to store the context data associated with the device (e.g., at 132) based on a timer (e.g., the “Hot Swap” timer 140). For example, the battery event manager may compare the timer (e.g., the “Hot Swap” timer 140) with the first timer threshold T1 142 at 120 and the second timer threshold T2 144 at 130, and perform corresponding steps based on the comparison results.

In some aspects, if the timer is greater than a first timer threshold, the battery event manager is configured to, at 610, transition the boot core to a deeper LPM than the LPM and to transition the SoC to a sleep state. For example, referring to FIG. 1, if the timer (e.g., the “Hot Swap” timer 140) is greater than a first timer threshold T1 142 (e.g., at 120), in stage 2 126, the battery event manager may be configured to, at 122, transition the boot core to a deeper LPM than the LPM and, at 124, transition the SoC to a sleep state.

In some aspects, the SoC may be coupled to a capacitor for storing energy and for powering the SoC upon removal of the battery, and the first timer threshold (e.g., at 632) may be based on the capacitor having a particular percentage of remaining energy stored for powering the SoC. For example, referring to FIG. 1, the SoC may be coupled to a capacitor for storing energy and for powering the SoC upon removal of the battery, and the first timer threshold (e.g., T1 142) may be based on the capacitor having a particular percentage of remaining energy stored for powering the SoC.

In some aspects, the particular percentage is approximately 50%. For example, referring to FIG. 1, the first timer threshold (e.g., T1 142) may be based on the capacitor having approximately 50% of the remaining energy stored for powering the SoC.

In some aspects, at 622, after detecting a replacement of the battery (e.g., determining that the battery replacement process has completed at 634), the battery event manager may be configured to transition the SoC out of the sleep state. For example, referring to FIG. 4, after detecting a replacement of the battery (e.g., after receiving the notification from PMIC at 404) and the SoC is in stage 2 (e.g., at 420), the battery event manager may be configured to transition the SoC out of the sleep state (e.g., at 422).

In some aspects, if the timer is greater than a second timer threshold (which is greater than the first timer threshold), the battery event manager may be configured to wake up dynamic random access memory (DRAM) and copy the context data from the DRAM into non-volatile memory (e.g., at 612). For example, referring to FIG. 1, if the timer (e.g., the “Hot Swap” timer 140) is greater than a second timer threshold T2 144, in stage 3 136, the battery event manager may be configured to wake up DRAM and copy the context data from the DRAM into an NVM (e.g., at 132).

In some aspects, the SoC may be coupled to a capacitor for storing energy and for powering the SoC upon removal of the battery, and the second timer threshold (e.g., at 636) may be based on a time period for waking up the DRAM and copying the context data from the DRAM into the NVM and based on the capacitor having a particular percentage of remaining energy stored for powering the SoC upon completion of the copying of the context data from the DRAM into the NVM. For example, referring to FIG. 1, the second timer threshold T2 144 may be based on a time period for waking up the DRAM and copying the context data from the DRAM into the NVM (e.g., at 132) and based on the capacitor having a particular percentage of remaining energy stored for powering the SoC upon completion of the copying of the context data from the DRAM into the NVM.

In some aspects, the particular percentage is greater than 5%. For example, referring to FIG. 1, the second timer threshold T2 144 may be based on the capacitor having greater than 5% of the remaining energy stored for powering the SoC upon completion of the copying of the context data from the RAM into the NVM.

In some examples, after the device has stored the context data associated with the device (e.g., at 614), the device may determine whether the battery replacement process has completed (e.g., at 638). Once the battery replacement process has completed, the device (e.g., the SoC in the device) may initiate a cold boot wake-up process (e.g., at 624) to restore power and resume normal operation. In some examples, the device may restore the context data saved at 614 to facilitate the resumption of normal operation.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

The following examples are illustrative only and may be combined with aspects of other implementations or teachings described herein, without limitation.
Aspect 1 is a device including a SoC, the SoC configured to receive information from a power management integrated circuit (PMIC) that a battery in the device was removed or will be removed; and store, based on the received information, context data associated with the device.
Aspect 2 is the device of aspect 1, wherein a battery event manager in the SoC receives the information from the PMIC and stores the context data based on the received information.
Aspect 3 is the device of any of aspects 1 to 2, wherein the battery event manager is configured to transition one or more subsystems (SS) of the device to a power collapse (PC) mode and to transition a boot core of the device to a low power mode (LPM) upon receiving the information from the PMIC.
Aspect 4 is the device of aspect 3, wherein transitioning the one or more SS of the device to the PC mode includes transitioning one or more of: a modem into an emergency mode, a wireless local area network (WLAN) into an OFF mode, Bluetooth into an OFF mode, audio into an audio pause mode, a neural signal processing (NSP) SS into an LPM, a camera into an OFF mode, a video into an OFF mode, a graphics processing unit (GPU) into an OFF mode, a display into an ON mode, a global position system (GPS) into an OFF mode, or near field communication (NFC) into an OFF mode.
Aspect 5 is the device of aspect 3, wherein the battery event manager is configured to transition, after detecting a replacement of the battery, the boot core out of the LPM.
Aspect 6 is the device of aspect 3, wherein the battery event manager is configured to store the context data associated with the device based on a timer.
Aspect 7 is the device of aspect 6, wherein the battery event manager is configured to transition the boot core to a deeper LPM than the LPM and to transition the SoC to a sleep state upon determining the timer is greater than a first timer threshold.
Aspect 8 is the device of aspect 7, wherein the SoC is coupled to a capacitor for storing energy and for powering the SoC upon removal of the battery, and the first timer threshold is based on the capacitor having a particular percentage of remaining energy stored for powering the SoC.
Aspect 9 is the device of aspect 8, wherein the particular percentage is approximately 50%.
Aspect 10 is the device of aspect 9, wherein the battery event manager is configured to transition, after detecting a replacement of the battery, the SoC out of the sleep state.
Aspect 11 is the device of aspect 7, wherein the battery event manager is configured to wake up dynamic random access memory (DRAM) and to copy the context data from the DRAM into non-volatile memory upon determining the timer is greater than a second timer threshold greater than the first timer threshold.
Aspect 12 is the device of aspect 11, wherein the SoC is coupled to a capacitor for storing energy and for powering the SoC upon removal of the battery, and the second timer threshold is based on a time period for waking up the DRAM and copying the context data from the DRAM into the non-volatile memory and based on the capacitor having a particular percentage of remaining energy stored for powering the SoC upon completion of the copying of the context data from the DRAM into the non-volatile memory.
—Aspect 13 is the device of aspect 12, wherein the particular percentage is greater than 5%.

What is claimed is:

1. A device comprising a system-on-a-chip (SoC), wherein the SoC is configured to:
receive information from a power management integrated circuit (PMIC) that a battery in the device was removed or will be removed; and
store, based on the received information, context data associated with the device.

2. The device of claim 1, wherein the SoC comprises a battery event manager, wherein the battery event manager is configured to receive the information from the PMIC and to store the context data based on the received information.

3. The device of claim 2, wherein the battery event manager is configured to transition one or more subsystems (SS) of the device to a power collapse (PC) mode and to transition a boot core of the device to a low power mode (LPM) upon receiving the information from the PMIC.

4. The device of claim 3, wherein to transition the one or more SS of the device to the PC mode, the battery event manager is configured to transition one or more of:
a modem into an emergency mode,
a wireless local area network (WLAN) into an OFF mode,
Bluetooth into an OFF mode,
audio into an audio pause mode,
a neural signal processing SS into an LPM,
a camera into an OFF mode,
a video into an OFF mode,
a graphics processing unit (GPU) into an OFF mode,
a display into an ON mode,
a global position system (GPS) into an OFF mode, or
near field communication (NFC) into an OFF mode.

5. The device of claim 3, wherein the battery event manager is configured to
transition, after detecting a replacement of the battery, the boot core out of the LPM.

6. The device of claim 3, wherein the battery event manager is configured to store the context data associated with the device based on a timer.

7. The device of claim 6, wherein the battery event manager is configured to transition the boot core to a deeper LPM than the LPM and to transition the SoC to a sleep state upon determining the timer is greater than a first timer threshold.

8. The device of claim 7, wherein the SoC is coupled to a capacitor for storing energy and for powering the SoC upon removal of the battery, and the first timer threshold is based on the capacitor having a particular percentage of remaining energy stored for powering the SoC.

9. The device of claim 8, wherein the particular percentage is approximately 50%.

10. The device of claim 9, wherein the battery event manager is configured to transition, after detecting a replacement of the battery, the SoC out of the sleep state.

11. The device of claim 7, wherein the battery event manager is configured to wake up dynamic random access memory (DRAM) and to copy the context data from the DRAM into non-volatile memory upon determining the timer is greater than a second timer threshold greater than the first timer threshold.

12. The device of claim 11, wherein the SoC is coupled to a capacitor for storing energy and for powering the SoC upon removal of the battery, and the second timer threshold is based on a time period for waking up the DRAM and copying the context data from the DRAM into the non-volatile memory and based on the capacitor having a particular percentage of remaining energy stored for powering the SoC upon completion of the copying of the context data from the DRAM into the non-volatile memory.

13. The device of claim 12, wherein the particular percentage is greater than 5%.

14. A method of a system-on-a-chip (SoC) of a device, comprising:
receiving information from a power management integrated circuit (PMIC) that a battery in the device was removed or will be removed; and
storing, based on the received information, context data associated with the device.

15. The method of claim 14, wherein the SoC comprises a battery event manager, wherein the battery event manager is configured to receive the information from the PMIC and to store the context data based on the received information.

16. The method of claim 15, wherein the battery event manager is configured to transition one or more subsystems (SS) of the device to a power collapse (PC) mode and to transition a boot core of the device to a low power mode (LPM) upon receiving the information from the PMIC.

17. The method of claim 16, wherein transitioning the one or more SS of the device to the PC mode comprises transitioning one or more of:
a modem into an emergency mode,
a wireless local area network (WLAN) into an OFF mode,
Bluetooth into an OFF mode,
audio into an audio pause mode,
a neural signal processing SS into an LPM,
a camera into an OFF mode,
a video into an OFF mode,
a graphics processing unit (GPU) into an OFF mode,
a display into an ON mode,
a global position system (GPS) into an OFF mode, or
near field communication (NFC) into an OFF mode.

18. The method of claim 16, wherein the battery event manager is configured to
transition, after detecting a replacement of the battery, the boot core out of the LPM.

19. The method of claim 16, wherein the battery event manager is configured to store the context data associated with the device based on a timer.

20. The method of claim 19, wherein the battery event manager is configured to transition the boot core to a deeper LPM than the LPM and to transition the SoC to a sleep state upon determining the timer is greater than a first timer threshold.
